(19) United States
(12) Patent Application Publication
(10) Pub. No.: US 2010/0043595 A1
(43) Pub. Date: Feb. 25, 2010

(54) DRIVE FOR A MOVABLE FURNITURE ELEMENT

(76) Inventor: Klaus Mattle, Koblach (AT)

Correspondence Address: WENDEROTH, LIND & PONACK, L.L.P., 1030 15th Street, N.W.,, Suite 400 East, Washington, DC, 20005-1503, US

(21) Appl. No.: 12/606,428

(22) Filed: Oct. 27, 2009

Related U.S. Application Data
(63) Continuation of application No. PCT/AT2008/000152, filed on Apr. 25, 2008.

(30) Foreign Application Priority Data
May 7, 2007 (AT) A 695/2007

(51) Int. Cl. G05G 1/015; G05G 1/00

(52) U.S. Cl. 74/625

(57) ABSTRACT

A drive for a movable furniture element has an actuating element for moving the furniture element and a motor for driving the actuating element. The actuating element and the furniture element may at times be moved independently of one another, and a position measurement system is provided for determining both the position of the actuating element and the position of the furniture element.

The present invention concerns a drive for a movable furniture part, comprising an adjusting member for moving the furniture part and a motor for driving the adjusting member, wherein the adjusting member and the furniture part are at times movable independently of each other.

Drives of the general kind set forth are already known, in which the position or movement parameters derived therefrom of the adjusting member or the movable furniture part can be determined by way of a position measuring device.

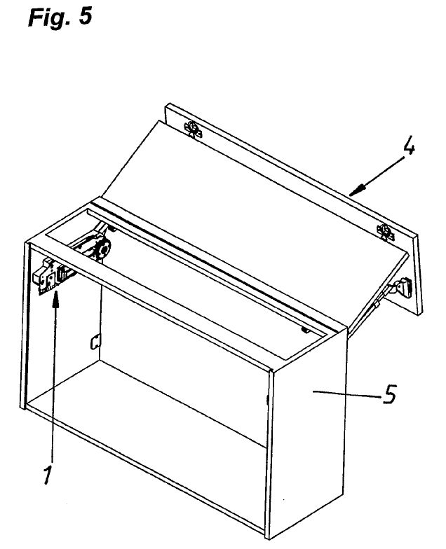

For example WO 2006/017864 A1 on pages 5 through 6 (fourth variant of the invention described in WO 2006/017864 A1) describes a drive for a movable furniture part comprising a position measuring device by which the position of the adjusting member (ejection lever) can be determined. In addition the above-indicated specification on page 7 thereof describes the possibility of coupling the position measuring device to the furniture part itself, instead of to the adjusting member. In the embodiment shown in FIGS. 18 and 20 that is effected either by way of a spring-loaded thrust member or by way of an entrainment member which can be coupled to the movable furniture part over a certain distance.

The state of the art suffers from the problem that it is not possible to detect the position or movement parameters derived therefrom selectively or simultaneously both of the furniture part and also the adjusting member, and more specifically independently of whether the adjusting member is or is not just in contact with the furniture part.

The object of the invention is to overcome that problem.

That object is attained by a drive having the features of claim 1.

Further advantageous configurations are defined in the appendant claims.

There can be various reasons why the adjusting member and the furniture part are at times movable independently of each other. For example it can be provided that the adjusting member, for moving the furniture part, can be loosely contacted with the furniture part. That situation arises when the adjusting member is in the form of an ejection lever or thrust member. More specifically the ejection lever or thrust member bears against the furniture part only over its pivotal or extension travel.

It can however also be the case that the adjusting member in itself is fixedly connected to the furniture part but a coupling is arranged in the drive train between the motor which drives the adjusting member and the furniture part, wherein the drive train can be disengaged by the coupling. It may be desirable for example if the movable furniture part is movable manually by a user without in that case the user being impeded by the motor. That is advantageous if the motor is defective or the user for example wants a higher speed than that of the furniture part when driven by the motor.

It can however also be the case that the coupling is in the form of an overload coupling to avoid damage to or indeed destruction of the adjusting member or the motor. Without such an overload coupling it can happen that the adjusting member, when the movable furniture part is loaded with excessive forces, transmits those forces to the motor or a transmission.

In regard to all those possible options, it is possible with a drive according to the invention to determine the position or movement parameters derived therefrom (such as speed or acceleration) of the adjusting member and/or the furniture part, even if the adjusting member and the furniture part are just moving independently of each other.

The fact that the position or movement parameters derived therefrom of the furniture part can be continuously determined means that it is for example possible to constantly maintain a touch-latch functionality in respect of the drive. This means that a user can cause activation of the motor by the application of a force to the furniture part and the change in position or speed of the furniture part, that is caused thereby. That is desirable in particular when the motor is active only over a part of the total travel of the furniture part in order to again trigger the motor.

The effect of determining the position or derived movement parameters of the adjusting member can also be used on the one hand to implement a touch-latch functionality. In this case therefore for example the motor is activated upon a change in the position or speed of the adjusting member.

On the other hand it can also be provided that the motor is intended by way of the adjusting member to implement a predetermined travel, speed or acceleration profile for the furniture part. To permit the dependency on the position or speed or acceleration in regulated relationship, it will be appreciated that there must be provided a suitable position measuring device and possibly a clock and a computing unit.

It is also possible to provide for collision monitoring by way of the position measuring device. The position (location or travel) of the movable furniture part is measured in that case and monitored by way of a control or regulating device for a change in speed or acceleration. The operation of ascertaining the speed or acceleration of the movable furniture part can be effected for example by forming the first or second derivative of the position in dependence on time. If the change in speed or acceleration differs from a reference value which was established earlier, then the motor can be switched off. Examples of collisions are a user who is standing under a movable item of furniture in the form of a flap and who blocks the closing movement of the flap, or an article projecting from a body or carcass of an item of furniture and which prevents a drawer or flap from closing.

In a particularly preferred embodiment of the invention it is provided that the position measuring device has at least one potentiometer. Particularly preferably however there are two potentiometers, in which case a respective potentiometer is associated with the adjusting member and the furniture part respectively. Absolute position determination can be effected by potentiometers. However purely incremental position determination may also be adequate for the invention.

It is particularly preferably provided that the motor is in the form of an electric motor.

If control or regulation of the drive is desired, it will be appreciated that a control or regulating device must be provided, to which the signals of the position measuring device can be passed.

It will be self-evident that the position measuring device can physically also be in the form of two components which are spatially separate from each other. Alternatively it is possible to provide a single component with which there are associated two measuring sensors (for the adjusting member and the furniture part) which operate separately from each other.

Further advantages and details of the invention will be apparent from the Figures and the related specific description. In the drawing:

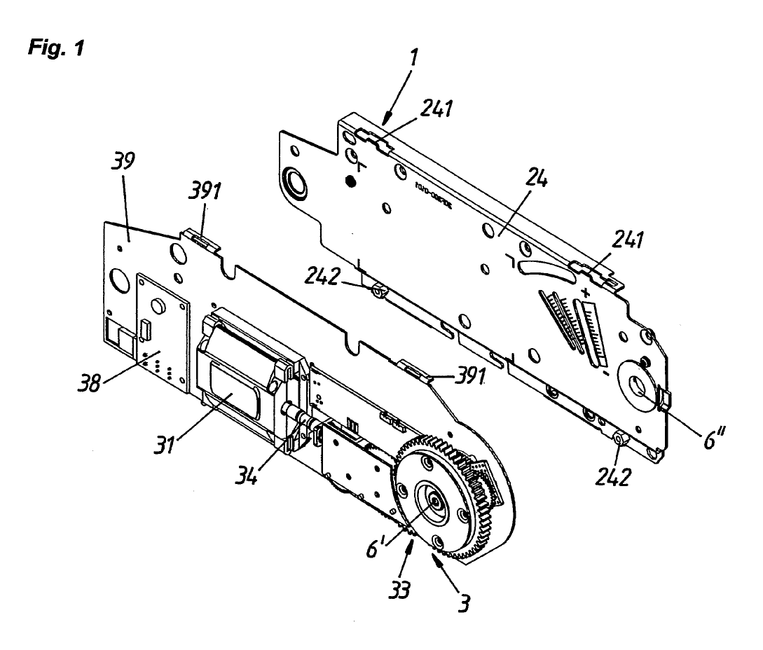

FIGS. 1 through 4 show various views of an embodiment of the invention by means of a flap drive system, and

FIG. 5 shows a perspective view of a body or carcass of an item of furniture with a fitted flap drive system as shown in FIGS. 1 through 4.

FIGS. 1 through 4 show an embodiment of the invention by means of a flap drive system 1.

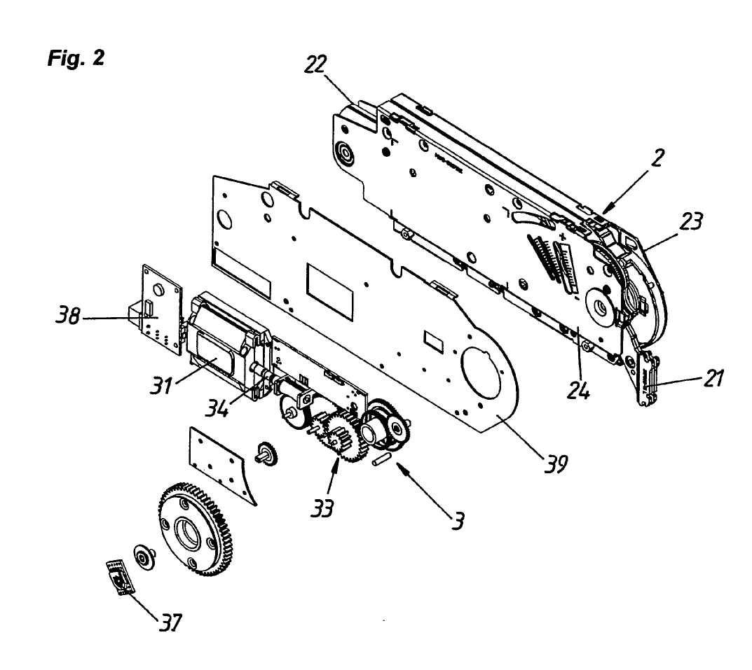

In this case FIG. 1 shows a cover surface 24 of a mechanical adjusting unit 2 which is not shown in greater detail in FIG. 2. The cover surface 24 has two projections 241 which serve to suspend the base plate 39 of the electric drive 3. In that case it is suspended by way of lugs 391. After it has been suspended in place the electric drive 3 and the mechanical adjusting unit 2 can be screwed together by way of screws, in which case in this embodiment the cover surface 24 has suitable receiving means 242 for the screws. It is further possible to see in FIG. 2 the transmission 33, the electric motor 31 and a coupling 34 connecting those two components together (in this embodiment it is of a mechanically flexible nature). In addition fixed on the base plate 39 is a circuit board 38 having the circuits of a control or regulating unit.

The interface 6 is here in the form of the central spindle 6′ of the electric drive 3 and a receiving means (not shown) for the spindle 6′, which is arranged behind a receiving opening 6″ on the adjusting unit 2.

FIG. 2 shows the mechanical adjusting unit 2 as an overall unit, as can already be fixed in a body or carcass of an item of furniture (not shown in FIG. 2). In this case the mechanical adjusting unit 2 has an adjusting arm 21 which is subjected to the action of a spring storage means 22 (here: a spring pack) which is not shown in FIG. 2 but which corresponds to the state of the art.

The housing of the adjusting unit 2 has a base surface 23 with which the adjusting unit 2 can be fixed to a carcass or body of an item of furniture. Arranged at a spacing therefrom and substantially parallel thereto is the cover surface 24 which serves for fixing the electric drive 3.

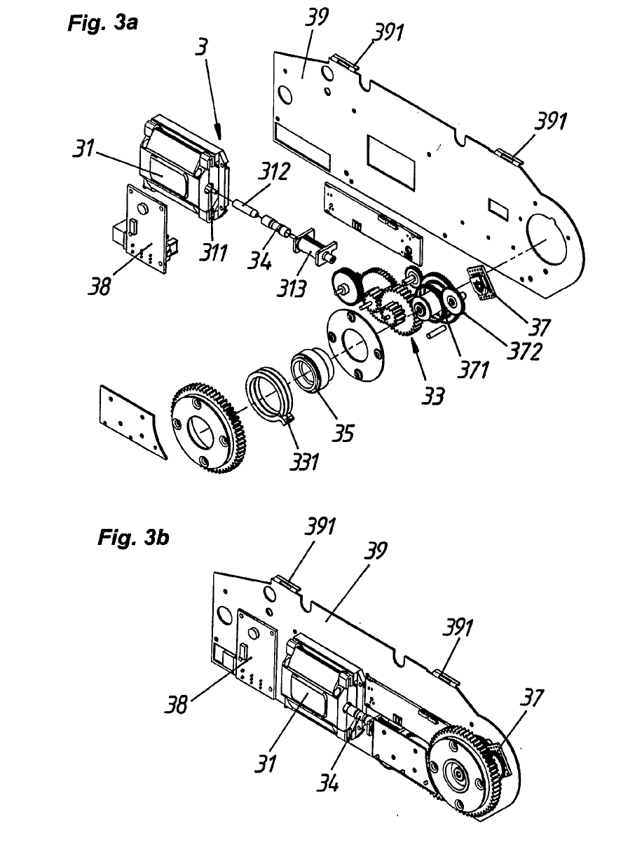

In relation to the electric drive 3, FIG. 2 in comparison with FIG. 1 shows a potentiometer 37 co-operating with the end stage of the transmission 33 (see in that respect the exploded view in FIG. 3). The position of the adjusting arm 21 and thus the position of the flap 4 (not shown in FIG. 2) can be determined by way of the potentiometer 37 as the end stage of the transmission 33 co-operates with the adjusting arm 21 without slippage by way of the interface 6 (not shown in FIG. 2).

A further potentiometer is not separately shown in the Figures, that potentiometer being provided directly on the circuit board 38 by suitable circuits. By way of that potentiometer it is possible to determine the position of the adjusting member, in the form of the drive output of the electric motor 31.

FIG. 3 shows the actual arrangement of the potentiometer 37 relative to the transmission 32. In this case a toothed ring 371 is non-rotatably connected to the end stage of the transmission 32 and co-operates with a gear 372 in such a way that there is a 2:1 transmission ratio in respect of the movement of the end stage of the transmission 33 to the gear 372. That means that the measuring range of the potentiometer 37 with which the gear 372 co-operates can be better utilised.

It can further be seen from FIG. 3 that a pin 312 is fitted in place at the drive output 311 of the electric motor 31, which pin 312 is fitted into the coupling 34 (here: a mechanically flexible tube coupling). Arranged on the other side of the coupling 34 in a housing 313 is a worm gear co-operating with the first stage of the transmission 33.

The electric drive 3 further has an overload coupling 331 and a freewheel coupling 35. In that case the overload coupling 331 prevents unwanted destruction of the gears of the transmission 33 by an excessive loading acting on the adjusting arm 21. The freewheel coupling 332 permits intervention on the part of a user when the flap 4 is being driven without being impeded in that respect by the motor 31.

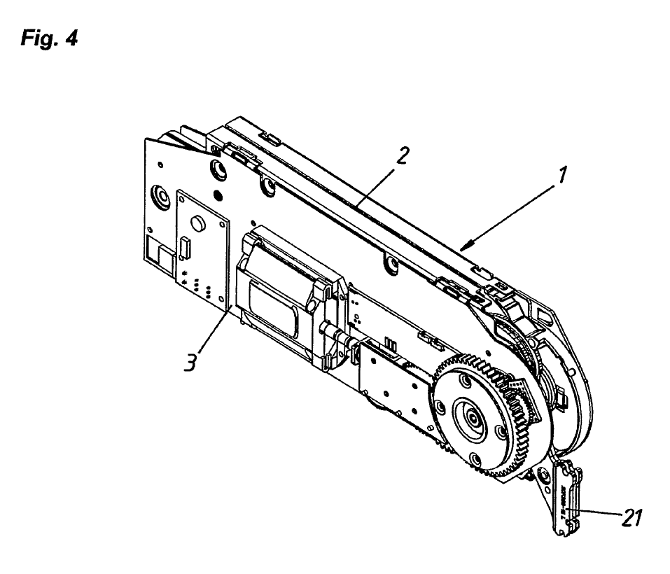

FIG. 4 again shows a perspective view of the flap drive system 1 as shown in previous FIGS. 1 through 3, wherein the electric drive 3 is fixed in the form of a self-contained component to the mechanical adjusting unit 2.

Although it is advantageous for the electric drive 3 to be fixed to an adjusting unit 2 even when the adjusting unit 2 is already mounted to a body or carcass 5 of an item of furniture (not shown here), it will be appreciated that pre-fabrication of the flap drive 1 can also be effected in the form shown in FIG. 4.

FIG. 5 shows a body or carcass 5 of an item of furniture with a flap 4 mounted movably thereto and a flap drive system 1 as shown in FIG. 1 through 4.

1. A drive for a movable furniture part, comprising an adjusting member for moving the furniture part and a motor for driving the adjusting member, wherein the adjusting member and the furniture part are at times movable independently of each other, wherein there is provided a position measuring device by which both the position of the adjusting member and also the position of the furniture part can be determined.

2. A drive as set forth in claim 1 wherein the adjusting member can be loosely contacted with the furniture part for movement thereof.

3. A drive as set forth in claim 2 wherein the adjusting member is in the form of an ejection lever or thrust member.

4. A drive as set forth in claim 1 wherein the adjusting member co-operates with the furniture part by way of a coupling for moving the furniture part.

5. A drive as set forth in claim 4 wherein the coupling has a freewheel means.

6. A drive as set forth in claim 4 wherein the coupling is in the form of an overload coupling.

7. A drive as set forth in claim 1 wherein the position measuring device has at least one and preferably two potentiometers.

8. A drive as set forth in claim 1 wherein the motor is in the form of an electric motor.

9. A drive as set forth in claim 1 wherein there is provided a control or regulating device to which the signals of the position measuring device can be fed.

10. A drive as set forth in claim 9 wherein the control or regulating device controls or regulates the motor in dependence on the signals of the position measuring device.
